(19) United States
(12) Patent Application Publication
(10) Pub. No.: US 2016/0221844 A1
(43) Pub. Date: Aug. 4, 2016

(54) Potential of Zero Charge Modified Carbon Based Electrode for Desalinization

(71) Applicant: University of Kentucky Research Foundation, Lexington, KY (US)

(72) Inventors: Xin Gao, Lexington, KY (US); Ayokunle Omosebi, Lexington, KY (US); James Richardson Landon, Lexington, KY (US); Kunlei Liu, Lexington, KY (US)

(73) Assignee: University of Kentucky Research Foundation, Lexington, KY (US)

(21) Appl. No.: 14/917,889

(22) PCT Filed: Sep. 10, 2014
(86) PCT No.: PCT/US14/54947

§ 371 Date: Mar. 9, 2016

Related U.S. Application Data
(63) Continuation-in-part of application No. 14/230,668, filed on Mar. 31, 2014.
(60) Provisional application No. 61/876,264, filed on Sep. 11, 2013.
(60) Provisional application No. 61/915,794, filed on Dec. 13, 2013.

(51) Int. Cl. C02F 1/469; C02F 1/46

(52) U.S. Cl. CPC C02F 1/4691; C02F 1/4604; C02F 2103/08

(57) ABSTRACT

An electrode is provided which includes a carbon-based material coated with a film which modifies the material's potential of zero charge. A method for producing the electrode includes steps of infiltrating a woven carbon cloth with a solution containing resorcinol and formaldehyde, polymerizing the solution infiltrated woven carbon cloth, subjecting the infiltrated and polymerized woven carbon cloth to a solvent-exchange process, carbonizing the woven carbon cloth and coating the carbonized woven carbon cloth with a film.

This utility patent application claims the benefit of priority in U.S. Provisional Patent Application Ser. Nos. 61/876,264, filed on Sep. 11, 2013, and 61/915,794, filed Dec. 13, 2013, and U.S. Nonprovisional patent application Ser. No. 14/230,668, filed on Mar. 31, 2014, the entirety of the disclosures of which are incorporated herein by reference.

### TECHNICAL FIELD

This document relates generally to the field of conductive carbon-based electrodes and, more particularly, to an electrode comprising a carbon sheet coated with a film. This film leads to the relocation of carbon's potential of zero charge (PZC).

### BACKGROUND

Charge efficiency is one of the important performance terms for a capacitive deionization (CDI) cell, which is given by the ratio of the equivalent charge of salt adsorbed to the charge passed during the adsorption step. This efficiency value can be increased by variations in the applied voltage to the cell and the salt concentration, and the use of the membrane assisted electrodes. Beyond these physical variations/modifications, charge efficiency also can be alternatively elevated by chemically modifying the PZC of carbon-based electrodes. If the carbon's PZC is located in the electrode's working domain, a charge inefficiency will occur due to co-ion repulsion. By coating a carbon material with a thin film, we are able to provide an electrode for CDI cell applications, which provides enhanced performance characteristics.

### SUMMARY

In accordance with the purposes and benefits described herein, an electrode is provided comprising a carbon sheet coated with a film. This coated film results in the modification, or relocation, of the carbon's PZC. The carbon sheet comprises a conductive carbon-based material. In an embodiment, the conductive carbon-based material is infiltrated with a solution comprising resorcinol and formaldehyde. In a further embodiment, the carbon-based material is woven and may comprise, for example, carbon cloth, carbon felt, or carbon yarn. A film is formed by dip-coating the carbon electrode in a solution followed by subsequent drying steps. The coating may have a thickness of between 1 Å and 100 nm.

In accordance with an additional aspect, a method is provided for making an electrode. That method comprises the steps of: (a) infiltrating a carbon-based material with a solution containing resorcinol and formaldehyde; (b) polymerizing the solution infiltrated onto the carbon-based material to obtain a polymerized material; (c) subjecting the polymerized material to a solvent-exchange process; (d) carbonizing the polymerized material to obtain a carbonized material; and (e) coating the carbonized material with a film. In accordance with the method, the subjecting step may include serially soaking the infiltrated carbon-based material in deionized water and acetone followed by air drying. Further, the method may include completing the carbonizing step at about 800-1100° C. for 30-360 min. In one embodiment the carbonizing step is completed at about 1,000° C. for about 120 minutes. In any embodiment, the carbonizing step may further comprise using a ramp rate of about 1 to 5° C. min⁻¹ for heating from and cooling to room temperature. Further, the carbonizing step includes using a N₂ or Ar gas supply with flow greater than 300 mL min⁻¹ during carbonizing in order to provide an inert atmosphere.

In one possible embodiment the solution used to infiltrate the carbon-based material has a mole ratio of resorcinol to formaldehyde of about 1:2. The coating step may further comprise dipping the carbonized carbon-based woven material into a silica solution. That silica solution may include tetraethyl orthosilicate. In one embodiment the solution includes tetraethyl orthosilicate, ethanol and nitric acid with a volumetric ratio of from 1:1:1 to 1:50:1. In another embodiment, the solution includes tetraethyl orthosilicate, ethanol and nitric acid with a volumetric ratio of from 1:10:1 to 1:30:1. In another embodiment, the solution includes tetraethyl orthosilicate, ethanol and nitric acid with a volumetric ratio of 1:20:1.

In an embodiment, the coating step may comprise (a) dipping the carbonized woven carbon cloth into the silica solution, (b) drying the carbonized woven carbon cloth following dipping and (c) repeating steps (a) and (b). The dipping may be done for three minutes followed by drying for thirty minutes. The method may further comprise cutting the electrode to a desired shape.

In one embodiment, methods described herein are applied to a carbon-based woven material. In a further embodiment, the carbon-based woven material comprises carbon cloth, carbon felt, or carbon yarn. In another embodiment, the carbon-based woven material comprises carbon cloth.

In one embodiment, the film is prepared from a solution comprising one or more of carbon nanotubes, silicon, organic-functionalized silicon, silica, organic-functionalized silica, copper, chitosan, alumina, titania, vanadia, zirconia, magnesia, any metal or metal oxide from any group 3 (IIIB) to group 12 (IIB) element, or any nonmetal.

In one embodiment, the film is prepared from a solution comprising one or more nonmetals, which are selected from the group consisting of silicon, germanium, boron, antimony, or tellurium.

These and other embodiments of the present invention will be set forth in the description which follows, and in part will become apparent to those of ordinary skill in the art by reference to the following description.

### BRIEF DESCRIPTION OF THE DRAWINGS

The accompanying drawings incorporated herein and forming a part of the specification, illustrate several aspects of the electrode made from a carbon-based material (e.g., carbon cloth) coated with a silica film and together with the description serve to explain certain principles thereof. In the drawings:

A schematic representation (FIGS. 1 and 2) shows the change in the functional groups at the surface of a carbon material before and after the modifications (e.g., TESO modification, HNO₃ treatment, air-oxidation, and electrochemical oxidation).

FIG. 1 represents that the unmodified carbon contains C═C, C—O, and O—H groups.

FIG. 2 indicates the use of TEOS modification (one of the modification methods) results in a significant change in the surface conditions. For instance, Si bonds were established on the carbon surface.

FIG. 3 gives the FTIR results to attest the change in the functional groups at the surface of a carbon material before and after the modifications. By comparison of the unmodified carbon (dashed line), the use of TEOS medication leads to the C═O, Si—C₆H₅, NO₂, and Si—O—C being formed (solid line).

Potential of zero charge (PZC) region (dashed square) of a carbon material can be relocated by using one of the modification methods mentioned above.

FIG. 4 gives an example of relocation of the PZC for the treated sample by the use of sulfuric acid solution (SAS) and sulfanilic acid solution (SNAS). As indicated in the magnified plot, the degree of PZC shifting is ˜0.3 V when the unmodified (pristine) carbon is compared.

FIG. 5 shows that not only the use of sulfuric acid solution (SAS) but also the used of electro-oxidative method results in the PZC region for the treated carbon being positively shifted.

FIG. 6 shows the PZC region of a carbon material can be detected by both cyclic voltammetry (CV) and electrochemical impedance spectroscopy (EIS). Both methods consistently suggest that the unmodified carbon (Pr) has a PZC region of ˜−0.15 V vs SCE, and the treated sample (electro-oxidative) has a PZC region of ˜0.5 V vs. SCE.

FIG. 7 shows that the PZC shifting of a carbon material can be achieved by the use of HNO₃ acid. The EIS spectra show the PZC region has been shifted from ˜−0.2 V to ˜0.2 V after HNO₃-treatment.

FIG. 8 shows the possible location of the PZC region of a carbon electrode within the respective potential distribution. This representation suggests that the deionization performance can be substantially boosted when the PZC region is out of the corresponding electrode's working domain, and vice versa. For example, when a CDI cell employs the treated carbon as the cathode and the untreated carbon as the anode, the separation performance indicated in FIG. 9 can be significantly enhanced.

Reference will now be made in detail to the present electrode embodiments, examples of which are illustrated in the accompanying drawings.

### DETAILED DESCRIPTION

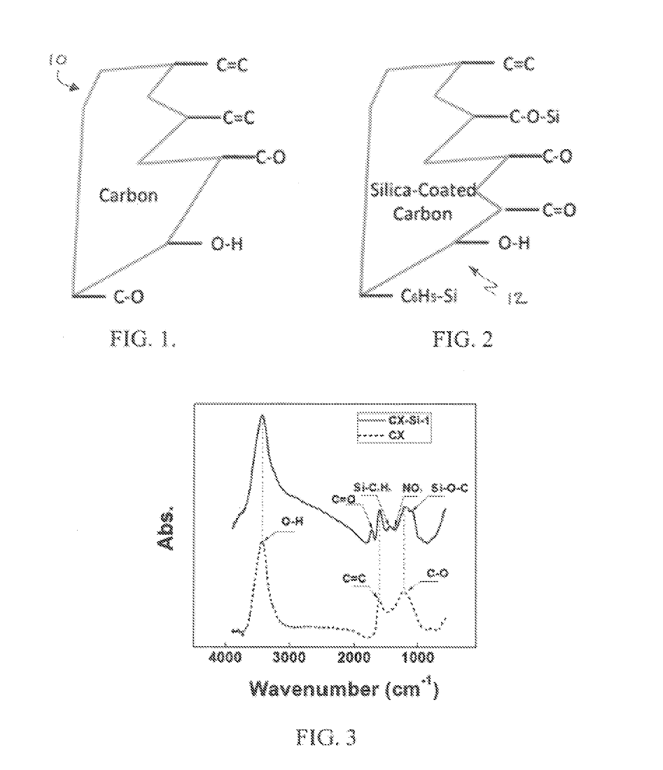

Reference is now made to FIG. 1 illustrating a carbon sheet 10 which comprises a conductive woven carbon cloth infiltrated with a solution containing resorcinol and formaldehyde. In one embodiment, that solution includes a mole ratio of resorcinol to formaldehyde in the range of from 5:1 to 1:5. In another embodiment, that solution includes a mole ratio of resorcinol to formaldehyde in the range of from 3:1 to 1:3. In another embodiment, that solution includes a mole ratio of resorcinol to formaldehyde of about 1:2. After infiltration the infiltrated woven carbon cloth is subjected to polymerization. This is followed by subjecting the infiltrated woven carbon to a solvent exchange process. That solvent exchange process includes serially soaking the infiltrated woven carbon cloth with deionized water and acetone. This is then followed by air drying.

Next the carbon is subjected to carbonizing. In one embodiment the carbonizing is completed at a temperature of between about 800 and about 1100° C. for between about 30 and about 360 minutes. In another embodiment, the carbonizing is completed at a temperature of between about 900 and about 1100° C. for between about 60 and about 240 minutes. In another embodiment, the carbonizing is completed at a temperature of between about 950 and 1050° C. for between about 90 and about 180 minutes. In another embodiment the carbonizing is completed at about 1,000° C. for about 120 minutes. In any embodiment, the method may include using a ramp rate of about 1 to 5° C. per minute for heating from and cooling to room temperature. In one embodiment the carbonizing is completed in an inert atmosphere. In one embodiment the inert atmosphere is provided by using a nitrogen gas supply with flow greater than 300 ml min⁻¹ during carbonizing. As illustrated in FIG. 1, the resulting carbon sheet 10 has a surface chemistry including carbon-carbon double bonds, carbon oxygen bonds and hydroxyl groups.

In accordance with an additional aspect of the present method, the carbon sheet 10 is subjected to coating with a film. In one embodiment, the carbon sheet 10 is dipped into a silica solution comprising tetraethyl orthosilicate (TEOS). In one embodiment the silica solution further comprises TEOS, ethanol and nitric acid with a volumetric ratio of 1:20:1. The pH of the solution is between about 2 and 8 pH. In one embodiment the method includes (a) dipping the carbon sheet into the silica solution, (b) drying the carbon sheet following dipping and (c) repeating steps (a) and (b) until the silica coating is provided at a desired thickness. In one embodiment that thickness is between 1 Å-10 nm. In another embodiment that thickness is between 10 nm-100 nm.

In accordance with an additional aspect of the present method, the coating step further comprises dipping said carbonized material into said solution for 1 to 30 minutes and drying said carbonized material for 5 to 500 minutes. In a further embodiment, the dipping may be for three minutes followed by drying for thirty minutes. The dried film coated carbon sheet forms an electrode 12 (see FIG. 2) including a unique surface chemistry. As illustrated in FIG. 2, that surface chemistry includes —Si and —COOH functional groups which increase the negative charge on the surface of the electrode. This promotes cation absorption and thereby increases the wettability of the electrode 12 to provide for enhanced performance. This is particularly true for an electrode 12 utilized in capacitive deionization applications such as for the desalinition (e.g., purification of salt water into drinking water). The electrode described herein may be used in supercapacitors and/or batteries.

Reference is made to the following example which further illustrates the electrode and the method of making the same.

### Preparation of Silica-Coated Carbon Sheets

The fabrication of carbon sheets coated with a silica film consisted of two steps—1) preparation of the carbon sheet and 2) dip-coating of the resulting carbon sheet within TEOS mixtures. In the following paragraphs, these steps will be detailed.

The carbon sheets were composed of commercially conductive carbon cloth (untreated, Fuel Cell Store) infiltrated with solutions mainly containing resorcinol (Sigma-Aldrich), and formaldehyde (37 wt % in methanol, Sigma-Aldrich) mixed in a 1:2 mole ratio. The detailed preparation of the solution will be introduced separately. After infiltration, the wet substrates were immobilized between two glass slides and sealed overnight. The sheets were then heated at 85° C. for a period of 24 hours in air, where the polymerization reaction was halted under such conditions. Subsequently, a solvent-exchange process was performed for the polymerized samples, in which the samples were subjected to 2-hours of soaking in deionized water, 2-hours of soaking in acetone, and 2-hours of air-drying. Finally, the samples were carbonized at 1000° C. for 2 hours using a ramp rate of 1 or 5° C. min⁻¹ for both heating and cooling from room temperature using a nitrogen gas supply with flow greater than 300 ml/min. The quartz tube used here was 48 inches long with an external diameter of 3 inches and an internal diameter of 2.75 inches.

Following fabrication of the carbon sheets, the carbon sheets were modified by the following steps in order to lead to a silica film being formed at the carbon surface: TEOS (Sigma-Aldrich), ethanol (Pharmco-Aaper), and HNO₃ (Acros) were vigorously mixed with a volumetric ratio of 1:20:1 in a sealed glass bottle for 1 hour at room temperature. The carbon sheets were dipped into the mixture for 3 min, and dried in an oven at 100° C. for 30 min. The carbon sheets were dipped repetitively into the TEOS mixture so as to vary the amount of silica deposited. All the received carbon sheets were kept in a vacuum desiccator before any characterization.

FTIR spectroscopy examined the chemical species at the carbon surface (FIG. 3). By comparison, new bands at ˜1730, ˜1430 and ˜1100 cm⁻¹ corresponding to C═O stretching, Si—C₆H₅ stretching, and Si—O—C stretching, respectively were found (dashed and solid line). This assignment indicates that the modification resulted not only in a thin-film containing Si, but also in the attachment of —COOH functional groups to the carbon surface. This change is schematically illustrated in FIGS. 1 and 2. The addition of these —Si and —COOH functional groups increased the negative charge on the carbon surface (promoting cation adsorption) and increased the wettability of the carbon.

Preparation of Carbon Xerogel Sheets with Different Porosities and Surface Areas
Effect of Na₂CO₃ Concentration on Porosities and Surface Areas

The solutions were prepared by mixing 10 g resorcinol, 14.74 g formaldehyde (37 wt % in methanol), 3 g of X M Na₂CO₃ solution (where X=0.01, 0.02, 0.1, 0.25, and 0.5) in a sealed glass bottle. These chemical agents were vigorously mixed for 0.5 hours at room temperature. The resulting solutions were subsequently examined using a pH meter. As expected, we found that the pH of the solutions were strongly affected using the Na₂CO₃ solutions with different concentrations. The corresponding results are listed in Table 1 (see below). It can be seen that an increase in the concentration of Na₂CO₃ solutions results in an increase in the pH of the solutions.

TABLE 1
Effect of Na₂CO₃ addition on pH of mixtures. In this study,
the mass of resorcinol and formaldehyde (37 wt % in methanol)
is fixed at 10 g and 14.74 g, respectively, resulting in the mole ratio
of resorcinol and formaldehyde being 1:2. Following this mixing, 3 g of
X M Na₂CO₃ solution was added, where X = 0.01, 0.02,
0.1, 0.25 and 0.5.

| X (concentration of | |
|---|---|
| Na₂CO₃)/M | pH |
| 0.01 | 2.62 |
| 0.02 | 4.55 |
| 0.1 | 6.62 |
| 0.25 | 7.17 |
| 0.5 | 7.58 |

The use of the same carbon xerogel sheet preparation procedure but solutions with different pH values yielded different isotherms measured by a porosity and surface area analyzer (Micrometrics, ASAP 2020). Based upon the isotherms, the corresponding pore volumes and surface areas were calculated using the BJH method and BET method, respectively, and the corresponding results can be seen in Table 2 (see below). It was found that the addition of Na₂CO₃ with different concentrations (the adjustment of solution's pH) has affected the porosities and surface areas of the resulting carbon sheets. In general, an increase in the Na₂CO₃ concentration leads to a decrease in the pore volume but an increase in the surface area.

TABLE 2
Effect of Na₂CO₃ addition on carbon xerogel sheets' porosities
and surface area. The porosities and surface areas were calculated
using BJH method based upon desorption isotherms.

| X (concentration of | Pore Volume | Surface Area |
|---|---|---|
| Na₂CO₃) (M) | (cm³ g⁻¹) | (m² g⁻¹) |
| 0.01 | 0.57 | 150.11 |
| 0.02 | 0.40 | 171.31 |
| 0.1 | 0.26 | 211.36 |
| 0.25 | 0.15 | 203.79 |
| 0.5 | 0.047 | 106.9 |

### Modification of PZC of Electrode Surface to Enhance Deionization Capability

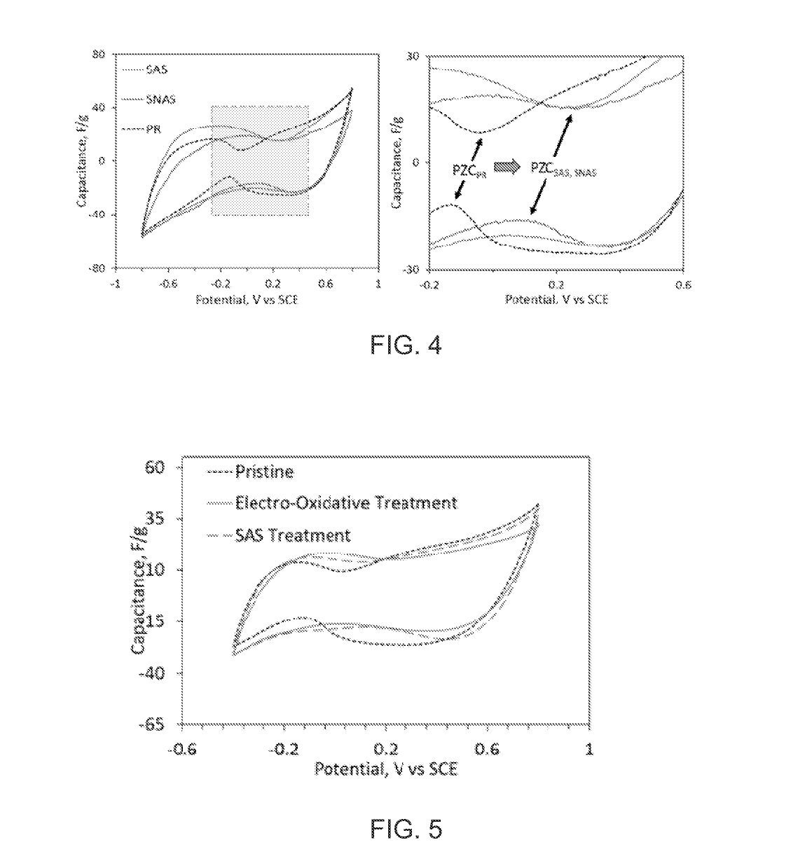

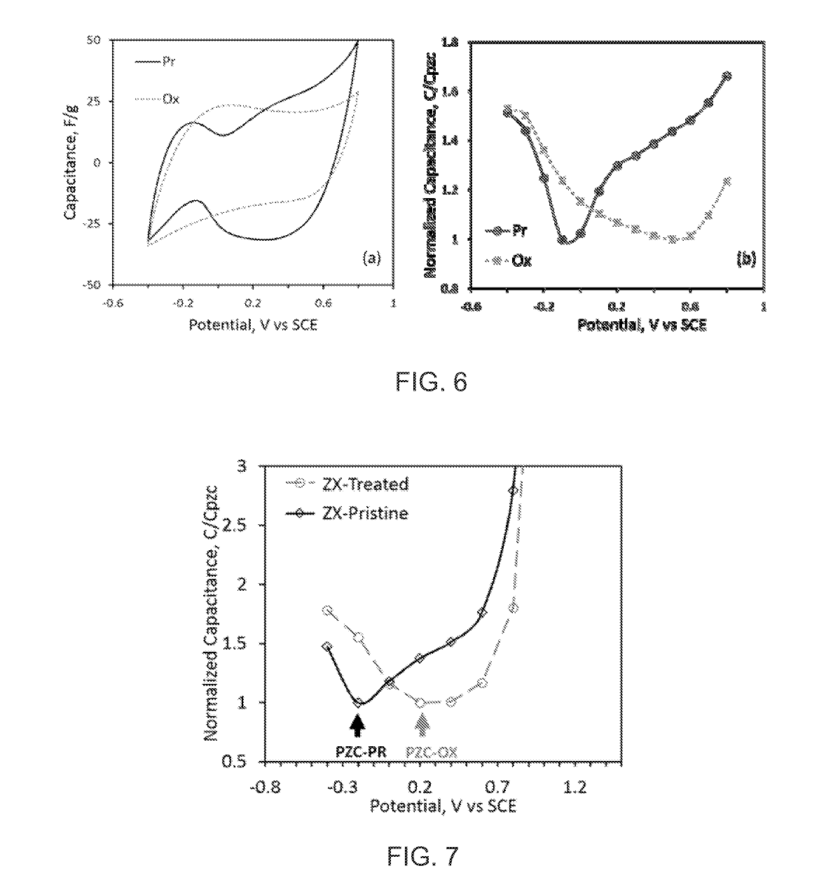

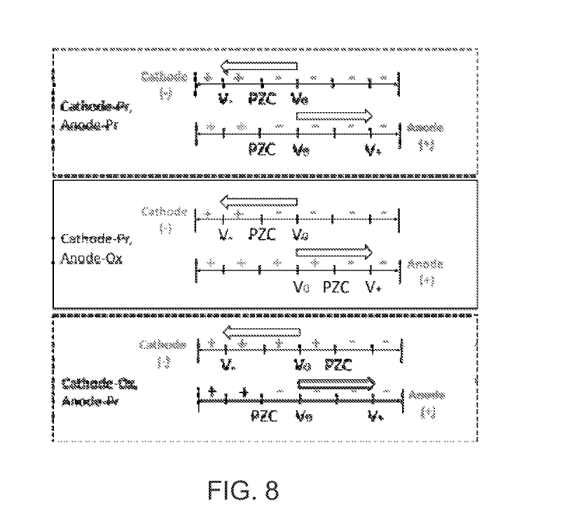

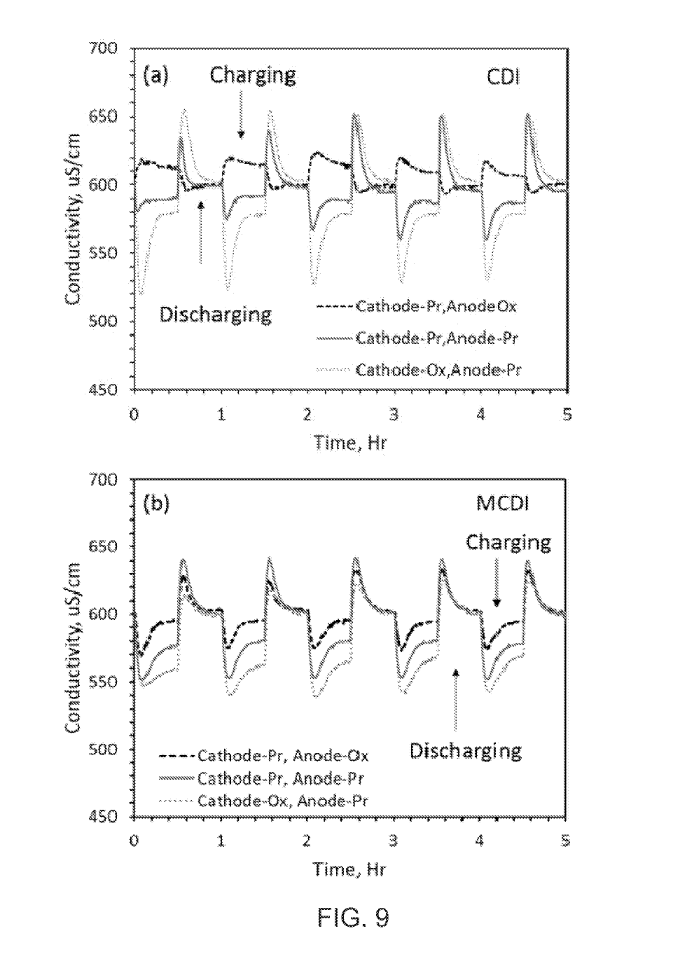

In an aspect, the PZC of the surface of an electrode as described herein may be modified to enhance deionization capability. Treatments for xerogel materials are shown using sulfuric acid (FIG. 4), sulfanilic acid (FIG. 4), and electrochemical oxidation (FIG. 5). Treatments for an activated carbon fiber cloth include electrochemical oxidation (FIG. 6) and nitric acid oxidation (FIG. 7). All of these treatments can be used with various carbon materials to shift the PZC and modify the salt removal capability of a capacitive deionization device. PZC shifting and ideal locations are shown in FIG. 8 with salt removal experiments for both capacitive deionization and membrane capacitive deionization being shown in FIG. 9.

PZC Modification Through Acid Treatments

The procedure for the HNO₃-treatment is as follows. A graduated cylinder with a film cover was used to heat 300 cm³ of ˜70% HNO₃ (Sigma-Aldrich) in a temperature-controlled coolant bath. When the temperature of HNO₃ was stable (at 20, 35, 50 and 80° C., selected by considering the principle of design of experiment), a carbon electrode, in one embodiment carbon xerogel (CX), with a geometric area of ˜70 cm² was placed into the cylinder for 1 h. After treatment, to remove any residual HNO₃ on the surface of the carbon, the treated carbon was washed with a great amount of deionized water until the pH value approached neutral. Subsequently, the wet carbon was post-treated at 160° C. overnight in a vacuum oven before testing. The treated carbon electrodes can be labeled as C-20, -35, -50 and -80, representing carbon sheet that was treated in HNO₃ at different temperatures, e.g., C-20 means that a carbon sheet was treated at 20° C. The same procedures can also be used for sulfuric acid (H₂SO₄) treatments at different temperatures and concentrations.

Organic sulfanilic acid was also used to treat the carbon electrode. The procedure is as follows. A mixture of water (H₂O), hydrochloric acid (HCl), sulfanilic acid (C₆H₇NO₃S), sodium nitrite (NaNO₂), and acetone ((CH₃)₂CO) in respective ratios of 39:1.3:1:0.4:1.4 by weight was prepared in a beaker kept in a water bath with temperature at ˜6° C. A carbon electrode, in one embodiment a CX sheet, was placed in the reaction product and left to sit for 12 hours. The CX sheet was withdrawn and repeatedly rinsed in deionized water until the solution pH was neutral.

PZC Modification Through Oxidation Treatment

The procedure for modifying a carbon electrode's PZC by oxidation treatments in the air is relatively straightforward. In one embodiment, a carbon electrode is heated at 350° C. for between 0.5 h and 4 h in an oven or furnace open to the air. The corresponding samples can be denoted as C-Ox-(0.5 h) and C-Ox-(4 h). This oxidation leads to the creation of oxide groups on the carbon electrode's surface which positively shifts the electrode's PZC. Temperatures above 300° C. and below 800° C. can be used for various time durations to modify the extent to which the PZC is shifted which will affect the resulting deionization performance of a capacitive deionization (CDI) cell.

In addition, to thermal oxidation in air or oxygen, the electrodes can be oxidized using electrochemical treatments. In one embodiment, carbon electrodes can be electrochemically oxidized at the anode using a cell potential of 1.5 V in a CDI cell for a period of 20 hours with a 4 mM NaCl electrolyte solution. In another embodiment, this cell potential can be anywhere from 0.4 V to 3 V for various time durations. This anode or positive electrode in this cell will subsequently have a positively-modified PZC which can be used to enhance deionization capacity in an asymmetrically configured CDI cell.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

1.-37. (canceled)

38. An electrode, comprising a carbon-based material coated with a film modifying the carbon-based material's potential of zero charge, wherein the film is prepared using a solution that includes at least one component selected from the group consisting of carbon nanotubes, silicon, organic functionalized silicon, silica, organic functionalized silica, —Si functional groups, —COOH functional groups, copper, chitosan, alumina, titania, vanadia, zirconia, magnesia, metals and metal oxides from any group 3 (IIIB) to group 12 (IIB) elements, silicon, germanium, boron, antimony, tellurium, and nonmetals.

39. An electrode, comprising a conductive carbon-based material coated with a film, wherein the film modifies a potential zero charge of carbon, and wherein the carbon-based material is at least one selected from the group consisting of carbon sheet, carbon-based material infiltrated with a solution containing resorcinol and formaldehyde, carbon-based woven material, carbon-based woven material infiltrated with a solution containing resorcinol and formaldehyde, carbon cloth, carbon cloth infiltrated with a solution containing resorcinol and formaldehyde, carbon felt, carbon felt infiltrated with a solution containing resorcinol and formaldehyde, carbon yarn, and carbon yarn infiltrated with a solution containing resorcinol and formaldehyde.

40. The electrode of claim 39, wherein the film is prepared from a solution that includes at least one component selected from the group consisting of carbon nanotubes, silicon, organic-functionalized silicon, silica, organic-functionalized silica, —Si functional groups, —COOH functional groups, copper, chitosan, alumina, titania, vanadia, zirconia, magnesia, any metal or metal oxide from any group 3 (IIIB) to group 12 (IIB) element, germanium, boron, antimony, tellurium, tetraethyl orthosilicate (TEOS), ethanol, nitric acid, and a nonmetal.

41. The electrode of any of claim 39 or 40, wherein the film has a thickness of from 1 Å to 100 nm.

42. A method of making an electrode, comprising:
(a) infiltrating a carbon-based material with a solution comprising resorcinol and formaldehyde to obtain an infiltrated material;
(b) polymerizing the solution infiltrated onto the carbon-based material to obtain a polymerized material;
(c) subjecting the polymerized material to a solvent-exchange process;
(d) carbonizing the polymerized material to obtain a carbonized material; and
(e) coating the carbonized material with a film that modifies a potential zero charge of the resultant electrode.

43. The method of claim 42, wherein the carbon-based material is selected from the group consisting of carbon-based woven material, conductive carbon-based woven material, carbon cloth, conductive carbon cloth, carbon felt, conductive carbon felt, carbon yarn, and conductive carbon yarn.

44. The method of claim 42, wherein the film is prepared from a solution that includes at least one component selected from the group consisting of carbon nanotubes, silicon, organic-functionalized silicon, silica, organic-functionalized silica, —Si functional groups, —COOH functional groups, copper, chitosan, alumina, titanic, vanadia, zirconia, magnesia, any metal or metal oxide from any group 3 (IIIB) to group 12 (IIB) element, germanium, boron, antimony, or tellurium, tetraethyl orthosilicate (TEOS), ethanol, nitric acid, and a nonmetal.

45. The method of any one of claims 42 to 44, wherein the subjecting step comprises serially soaking the infiltrated material in deionized water and acetone, followed by air drying.

46. The method of any one of claims 42 to 44, wherein the carbonizing step is completed at conditions selected from the group consisting of 800 to 1100° C. for 30 to 360 minutes, 900 to 1100° C. for 60 to 240 minutes, 950 to 1050° C. for 90 to 180 minutes, 1,000° C. for 120 minutes, a ramp rate of about 1° C. to 5° C. per minute for heating from and cooling to room temperature, a nitrogen gas supply with a flow rate greater than 300 ml min⁻¹ to provide an inert atmosphere during carbonizing, and an argon gas supply with a flow rate greater than 300 ml min⁻¹ to provide an inert atmosphere during carbonizing.

47. The method of any one of claims 42 to 44, wherein a mole ratio of resorcinol to formaldehyde in the solution containing resorcinol and formaldehyde is selected from the group consisting of a range of no more than 5 moles of resorcinol and no less than 1 mole of formaldehyde to no more than 1 mole of resorcinol and no less than 5 moles of formaldehyde, a range of no more than 3 moles of resorcinol and no less than 1 mole of formaldehyde to no more than 1 mole of resorcinol and no less than 3 moles of formaldehyde, and a range of no more than 2 moles of resorcinol and no less than 1 mole of formaldehyde to no more than 2 moles of resorcinol and no less than 1 mole of formaldehyde.

48. The method of any one of claims 42 to 44, wherein the coating step comprises dipping the carbonized material into a silica solution, wherein the solution further comprises tetraethyl orthosilicate, ethanol, and nitric acid with a volumetric ratio selected from a range of 1:1:1 to 1:50:1, a range of 1:10:1 to 1:30:1, and a range of 1:20:1.

49. The method of any one of claims 42 to 44, wherein the coating step comprises
(a) dipping the carbonized material into a silica solution,
(b) drying the carbonized material following the dipping step, and
(c) repeating steps (a) and (b).

50. The method of any one of claims 42 to 44, wherein the coating step further comprises dipping the carbonized material into the solution for 1 to 30 minutes and drying the carbonized material for 5 to 500 minutes.

51. The method of any one of claims 42 to 44, further comprising cutting the electrode to a desired shape.

52. The method of any one of claims 42 to 44, further comprising including Na₂CO₃ in the solution of resorcinol and formaldehyde and altering the concentration of Na₂CO₃ in the solution to control porosity and surface area of resulting electrode, wherein concentration of Na₂CO₃ in the solution is proportional to pH of the solution, is proportional to surface area of the resultant electrode, and is inversely proportional to pore volume of the resulting electrode.

53. Use of the electrode of any one of claims 38 to 41 in desalination.

54. Use of the electrode of any one of claims 38 to 41 in a device selected from the group consisting of supercapacitors, batteries, and batteries containing supercapacitors.
